(19) United States
(12) Patent Application Publication
(10) Pub. No.: US 2020/0246681 A1
(43) Pub. Date: Aug. 6, 2020

(54) Apparatus and Method for Double-Valued Playing Cards

(71) Applicant: Ying New York LLC, Brooklyn, NY (US)

(72) Inventor: Ying Chen, Brooklyn, NY (US)

(21) Appl. No.: 16/513,567

(22) Filed: Jul. 16, 2019

Related U.S. Application Data
(60) Provisional application No. 62/800,013, filed on Feb. 1, 2019.

(51) Int. Cl. A63F 1/02; G06K 7/14; G06F 16/955; A63F 1/18

(52) U.S. Cl. CPC A63F 1/02; G06K 7/1408; A63F 2001/0483; A63F 1/18; G06F 16/955

(57) ABSTRACT

The present disclosure provides decks of the double-valued playing cards, and methods of making the same. Specifically, the present disclosure provides a deck of playing cards comprising a fixed number of double-valued playing cards, and each double-valued playing card contains two values; the first value is selected from a group consisting of values of a first single-valued playing card deck, and each value of the first single-valued playing card deck can only be selected once; the second value is selected from a group consisting of values of a second single-valued playing card deck, and each value of the second single-valued playing card deck can only be selected once.

### CROSS REFERENCE

This application incorporates its entirety and claims priority to U.S. provisional patent application No. 62800013 filed on Feb. 1, 2019.

### BACKGROUND

### 1. Field of the Discovery

The present disclosure relates generally to a deck of playing cards comprising double-valued cards and methods of making the same.

### 2. Background Information

The standard 52-card deck is the most common deck of playing cards used today. Each of the cards has only one value that includes four suits: clubs ( [symbol] ), diamonds (♦), hearts (♥), and spades ( [symbol] ), and each suit consisting of thirteen ranks from 2 through A (ace). The standard playing cards have been known to use for card games for hundreds of years. Many card games are popular and well loved by the general public.

From time to time, some changes of playing and/or betting rules of games have appeared and have been adapted to increase thrills of the games.

One alteration of the standard deck has been to provide a set of cards in which each individual card represents more than one value, as indicated on its face. For example, U.S. Pat. No. 821,781 to Cadwallader discloses a set of cards with two values on the face of each individual card, and from which one value may be selected for play as desired by the player. U.S. Pat. No. 4,170,358 to Hancock discloses a deck of 52 cards wherein 48 cards are configured as double-valued cards having two zones with each zone assigned a card value ranging from three through ace configured such that the card value in one zone is distinctly different from the card value in the other zone.

However, neither Cadwallader nor Hancock disclose how each deck was produced or any additional limitations in setting the values of each card in a specific deck.

In addition, a manufacture tends to produce uniform decks of the playing cards with the same set of values, regardless single or double card values, to minimize the manufacture cost. However, such limitation would create predictability, decrease versatility, and increase the opportunity for a player to perform card counting.

### SUMMARY

The present disclosure provides decks of the double-valued playing cards, and methods of making the same. In one aspect, the present disclosure provides a deck of playing cards comprising a fixed number of double-valued playing cards, and each double-valued playing card contains two values; wherein the first value is selected from a group consisting of values of a first single-valued playing card deck, and each value of the first single-valued playing card deck can only be selected once; the second value is selected from a group consisting of values of a second single-valued playing card deck, and each value of the second single-valued playing card deck can only be selected once. Because each value of the double-valued card is selected from a different deck, the possible combinations of each deck of double-valued playing cards is enormous. When the first value and/or the second value are/is randomly selected from its corresponding deck, it is highly likely that no two decks of double-valued playing cards are identical and each deck is virtually unique.

In one embodiment, the first single-valued playing card deck is identical to the second single-valued playing card deck. In yet another embodiment, both the first single-valued playing card deck and the second single-valued playing card deck are consisting of four suits: clubs ( [symbol] ), diamonds (♦), hearts (♥), and spades ( [symbol] ), and each suit consisting of thirteen ranks from 2 through A (ace).

In one embodiment, there is no two double-valued playing cards that are identical.

In one aspect, the present disclosure provides a deck of playing cards comprising a fixed number of double-valued playing cards, wherein one value is positioned on the upper left-hand corner of the playing card, the other value is positioned upside-down on the lower right-hand corner of the playing card.

In another aspect, the present disclosure provides a deck of playing cards comprising a fixed number of double-valued playing cards, wherein the first value is positioned on the upper left-hand corner of the playing card, the second value is positioned below the first value on the upper left-hand corner of the playing card, the second value is positioned upside-down on the lower right-hand corner of the playing card, and the first value is positioned upside-down on the lower right-hand corner of the playing card on top of the second value that is positioned upside-down on the lower right-hand corner of the playing card.

In one aspect, the present disclosure provides a deck of playing cards comprising a fixed number of double-valued playing cards, wherein the first value is randomly selected from a group consisting of a first single-valued playing card deck, or the second value is randomly selected from a group consisting of a second single-valued playing card deck, or both the first value and the second value are randomly selected from their corresponding decks.

In one aspect, the present disclosure provides a deck of playing cards comprising a fixed number of double-valued playing cards, wherein the fixed number of double-valued playing cards is 52.

In one specific aspect, the present disclosure provides a deck of playing cards comprising a fixed number of double-valued playing cards, wherein the fixed number of double-valued playing cards is 52, there is no two double-valued playing cards that are identical, and the first value is randomly selected from a first single-valued playing card deck, or the second value is randomly selected from a second single-valued playing card deck, or both the first value and the second value are randomly selected from their corresponding decks.

In one aspect, the present disclosure provides a deck of playing cards that is visually the same as a deck of the playing cards but comprises 104 values out of which two values instead of one displaying on the face of each card. Each value, that includes one of thirteen ranks from 2 through A (ace) and each of the four suits: clubs ( [symbol] ), diamonds (♦), hearts (♥) and spades ( [symbol] ), appears two times in a single deck.

In another aspect, the present disclosure provides a deck of cards of which each card is formed with the values of two cards that are separately drawn from two identical single-valued decks of playing cards. Therefore, each deck of the present invention uniquely comprises values of two decks of playing cards.

In another aspect, the present disclosure provides a deck of cards of which each card is formed with the values of two cards that are separately drawn from two different single-valued decks of playing cards. Therefore, each deck of the present invention uniquely comprises values of two decks of playing cards.

In one aspect, the present disclosure provides a deck of cards of which each card is formed with the values of two cards that are separately and randomly drawn from two different single-valued decks of playing cards. Therefore, each deck of the present invention uniquely comprises values of two decks of playing cards.

In one aspect, the present disclosure provides a deck of cards of which each card is formed with the values of two cards that are separately and randomly drawn from two identical single-valued decks of playing cards. Therefore, each deck of the present invention uniquely comprises values of two decks of playing cards.

The present disclosure further provides methods of making the deck of double-valued playing cards described herein. In one aspect, the present disclosure provides a method of making the deck of double-valued playing cards, comprising steps of:

a. drawing a first card from a first single-valued playing card deck, wherein each value of the first single-valued playing card deck can only be selected once;

b. drawing a second card from a second single-valued playing card deck, wherein each value of the second single-valued playing card deck can only be selected once;

c. combining the values of the first and the second cards to form one double-valued playing card; and

d. repeating steps a-c until all the double-valued playing cards are formed.

In another aspect, the present disclosure provides a method of making the deck of double-valued playing cards, wherein the deck of the playing cards does not contain the identical double-valued playing cards, comprising steps of:

a. drawing a first card from a first single-valued playing card deck, wherein each value of the first single-valued playing card deck can only be selected once;

b. drawing a second card from a second single-valued playing card deck, wherein each value of the second single-valued playing card deck can only be selected once,

c. combining the values of the first and the second cards to form one double-valued playing card, wherein if the double-valued card is identical to one of the previously formed double-valued cards in the deck of playing cards, returning the second card back to the second single-valued playing card deck and repeating step b until the double-valued card is not identical to any of the previously formed double-valued cards in the deck of playing cards; and

d. repeating steps a-c until all the double-valued playing cards are formed.

In another aspect, the present disclosure provides a method of making the deck of double-valued playing cards, wherein the deck of the playing cards does not contain the identical double-valued playing cards, comprising steps of:

a. manufacturing a card database consisting a group of double-valued cards, wherein each double-valued playing card contains two values, the first value is selected from a group consisting of values of a first single-valued playing card deck, the second value is selected from a group consisting of values of a second single-valued playing card deck,

the card database is consisting of all the possible double-valued playing card combinations of the first single-valued playing card deck and the second single-valued playing card deck, and

no two cards in the card database is identical;

b. drawing a first card from a first single-valued playing card deck, wherein each value of the first single-valued playing card deck can only be selected once;

c. drawing a second card from a second single-valued playing card deck, wherein each value of the second single-valued playing card deck can only be selected once;

d. combining the values of the first and the second cards to form one double-valued playing card, wherein if the double-valued card is identical to one of the previously formed double-valued cards in the deck of playing cards, returning the second card back to the second single-valued playing card deck and repeating step c until the double-valued card is not identical to any of the previously formed double-valued cards in the deck of playing cards;

e. selecting the double-valued card from the card database, which has the same values as the double-valued card formed in step d, to be one of the double-valued card in the deck of playing cards;

f. repeating steps b-e until all the double-valued playing cards are formed.

In another aspect, the present disclosure provides a method of making the deck of double-valued playing cards, wherein the deck of the playing cards contains 52 double-valued playing cards, with no two double-valued playing cards that are identical, comprising steps of:

a. drawing a first card from a first single-valued playing card deck, wherein each value of the first single-valued playing card deck can only be selected once;

b. drawing a second card from a second single-valued playing card deck, wherein each value of the second single-valued playing card deck can only be selected once;

c. combining the values of the first and the second cards to form one double-valued playing card, wherein if the double-valued card is identical to one of the previously formed double-valued cards in the deck of playing cards, returning the second card back to the second single-valued playing card deck and repeating step b until the double-valued card is not identical to any of the previously formed double-valued cards in the deck of playing cards; and

d. repeating steps a-c until all the 52 double-valued playing cards are formed.

In another aspect, the present disclosure provides a method of making the deck of double-valued playing cards, wherein the deck of the playing cards contains 52 double-valued playing cards, with no two double-valued playing cards that are identical, comprising steps of:
a. manufacturing a card database consisting a group of double-valued cards, wherein each double-valued playing card contains two values,
   the first value is selected from a group consisting of values of a first single-valued playing card deck,
   the second value is selected from a group consisting of values of a second single-valued playing card deck,
   the first single-valued playing card deck and the second single-valued playing card deck are identical, and are consisting of four suits: clubs ( [symbol] ), diamonds (♦), hearts (♥), and spades ( [symbol] ), and each suit consisting of thirteen ranks from 2 through A (ace),
   the card database is consisting of all the possible double-valued playing card combinations of the first single-valued playing card deck and the second single-valued playing card deck, and
   no two cards in the card database is identical;
b. drawing a first card from a first single-valued playing card deck, wherein each value of the first single-valued playing card deck can only be selected once;
c. drawing a second card from a second single-valued playing card deck, wherein each value of the second single-valued playing card deck can only be selected once;
d. combining the values of the first and the second cards to form one double-valued playing card, wherein if the double-valued card is identical to one of the previously formed double-valued cards in the deck of playing cards, returning the second card back to the second single-valued playing card deck and repeating step c until the double-valued card is not identical to any of the previously formed double-valued cards in the deck of playing cards;
e. selecting the double-valued card from the card database, which has the same values as the double-valued card formed in step d, to be one of the double-valued card in the deck of playing cards;
f. repeating steps b-e until all the 52 double-valued playing cards are formed.

In one specific aspect, the present disclosure provides a card database contains a total of 1378 unique double-valued cards.

In another specific aspect, the present disclosure provides a deck of 52 unique double-valued playing cards, and each card is selected from a card database containing a total of 1378 unique double-valued cards.

In another aspect, the present disclosure provides decks of playing cards, wherein there is no two decks are identical.

In another aspect, decks of playing cards of the present disclosure are generated by an electronic device or a server, including but not limited to, a computer, a smartphone, and/or a network server.

Where applicable or not specifically disclaimed, any one of the embodiments described herein are contemplated to be able to combine with any other one or more embodiments or aspects, even though the embodiments are described under different aspects of the invention. These and other embodiments are disclosed or are obvious from and encompassed by, the following Detailed Description, including the Drawings and Examples herein.

### BRIEF DESCRIPTION OF THE DRAWINGS

The following detailed description, given by way of example, but not intended to limit the invention solely to the specific embodiments described, may best be understood in conjunction with the accompanying drawings.

FIGS. 1a and 1b illustrates examples of double-valued playing cards.

FIG. 2 illustrates an example of a deck of cards of which each card is formed from two cards that are separately drawn from two decks of playing cards.

FIG. 3 illustrates an example of a deck of cards of which each card is formed from two cards that are separately drawn from two decks of playing cards, wherein there is no two double-valued playing cards that are identical.

FIGS. 4a, 4b and 4c illustrates an example of the cards in a standard blackjack game.

FIGS. 5a and 5b illustrates an example of the cards in a standard poker game.

FIG. 6 illustrates an exemplary embodiment of the identifier portion in accordance with an aspect of the invention.

### DETAILED DESCRIPTION

The present disclosure provides decks of the double-valued playing cards, and methods of making the same. Specifically, the present disclosure provides a deck of playing cards comprising a fixed number of double-valued playing cards, and each double-valued playing card contains two values; the first value is selected from a group consisting of values of a first single-valued playing card deck, and each value of the first single-valued playing card deck can only be selected once; the second value is selected from a group consisting of values of a second single-valued playing card deck, and each value of the second single-valued playing card deck can only be selected once. Because each value of the double-valued card is selected from a different deck, the possible combinations of each deck of double-valued playing cards is enormous. When the first value and/or the second value are/is randomly selected from its corresponding deck, it is highly likely that no two decks of double-valued playing cards are identical and each deck is virtually unique.

The following is a detailed description of the invention provided to aid those skilled in the art in practicing the present invention. Those of ordinary skill in the art may make modifications and variations in the embodiments described herein without departing from the spirit or scope of the present invention. Unless otherwise defined, all terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety and may be employed in the practice of the present invention.

Although the detailed description of the invention uses the words “first” and “second”. The words “first” and “second” are interchangeable and merely for the purpose of clear description.

Although any double-valued playing cards and methods of making the same similar or equivalent to those described herein can also be used in the practice or testing of the present invention, the preferred embodiments and methods are now described.

Unless defined otherwise, all terms used herein have the meaning commonly understood by a person skilled in the art to which this invention belongs.

The following terms may have meanings ascribed to them below, unless specified otherwise. However, it should be understood that other meanings that are known or understood by those having ordinary skill in the art are also possible, and within the scope of the present invention. In the case of conflict, the present specification, including definitions, will control. In addition, the materials, methods, and examples are illustrative only and not intended to be limiting.

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

Any aspects/embodiments or methods provided herein can be combined with one or more of any of the other aspects/embodiments and methods provided herein.

As used herein in the specification and in the claims, the phrase “playing card,” in reference to a list of one or more elements, should be understood to mean any playing card, wherein the playing card is a piece of specially prepared heavy paper, thin cardboard, plastic-coated paper, cotton-paper blend, or thin plastic, marked with distinguishing motifs and used as one of a set for playing card games. The phrase “standard playing cards,” in reference to a list of one or more elements, should be understood to mean a 52 single-valued playing cards deck consisting of four suits: clubs ( [symbol] ), diamonds (♦), hearts (♥), and spades ( [symbol] ), and each suit includes an Ace, depicting a single symbol of its suit, a King, Queen, and Jack, each depicted with a symbol of their suit; and ranks two through ten, with each card depicting that number of pips of its suit. As well as these 52 cards, commercial packs often include between one and four jokers, most often two. Although present invention encompasses any types of playing cards, for illustration purposes, the exemplary embodiments of the present invention use standard playing cards.

Reference will now be made in detail to exemplary embodiments of the invention. While the invention will be described in conjunction with the exemplary embodiments, it will be understood that it is not intended to limit the invention to those embodiments. To the contrary, it is intended to cover alternatives, modifications, and equivalents as may be included within the spirit and scope of the invention as defined by the appended claims.

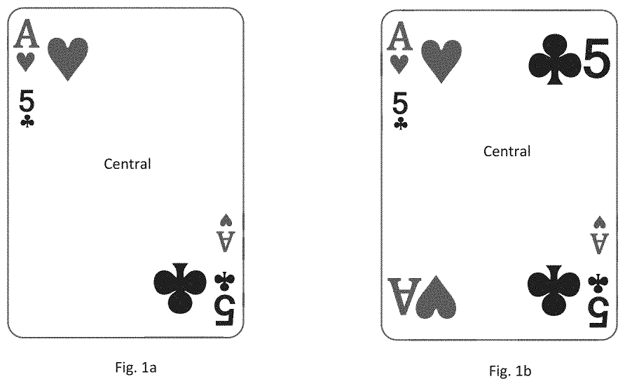

In one aspect, a deck of playing cards of the present invention comprises double-valued cards of which each on the face displays two randomly or pre-determined values that are the same as those of modern standard 52-card playing cards. The face of each card is divided into four corner areas and central area. On the version 1 (referring to the FIG. 1(a)), on the upper left-hand area and lower right-hand area of a card in a selected vertical orientation, two values oriented vertically of which one value is positioned on top of the other. On the version 2 (referring to the FIG. 1(b)), four corners including the upper right-hand and lower left-hand corners also display two values to facilitate the visual recognition for the players in games. The central area of each card can depict any design of choices. When playing card games with double-valued cards, one of two values could be selected at the choices of players to their best advantages; or both values could be utilized as rules of games apply.

In one specific aspect, the present disclosure provides a deck of playing cards comprising a fixed number of double-valued playing cards, wherein one value is positioned on the upper left-hand corner of the playing card, the other value is positioned upside-down on the lower right-hand corner of the playing card.

In another specific aspect, the present disclosure provides a deck of playing cards comprising a fixed number of double-valued playing cards, wherein the first value is positioned on the upper left-hand corner of the playing card, the second value is positioned below the first value on the upper left-hand corner of the playing card, the second value is positioned upside-down on the lower right-hand corner of the playing card, and the first value is positioned upside-down on the lower right-hand corner of the playing card on top of the second value that is positioned upside-down on the lower right-hand corner of the playing card.

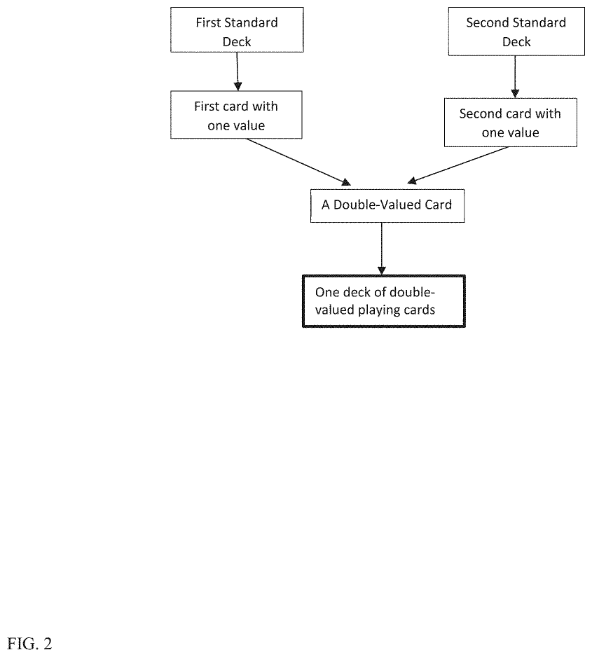

In another embodiments, the present invention to provide an improved deck of playing cards that is visually the same as a deck of the standard playing cards but comprises 104 values out of which two values instead of one displaying on the face of each card. The two values on a card could be randomly or pre-determinedly selected from the 52 values of a deck of standard playing cards. The present invention can be imagined as a deck of cards of which each card is formed from two cards that are separately drawn from two decks of standard playing cards, referring to the FIG. 2. Therefore, each deck of the present invention uniquely comprises two decks of standard playing cards.

In other embodiments, the present disclosure provides a deck of cards of which each card is formed with the values of two cards, which are separately drawn from two different single-valued decks of standard playing cards, and at least one of the two cards is randomly drawn from its corresponding single-valued decks of standard playing cards. If the two cards are randomly selected from two decks of playing cards, or only one card is randomly selected and the other card is selected in order, this random selection process produces astronomical number of version of decks. It is highly likely that no two decks of playing cards are identical and each deck is virtually unique.

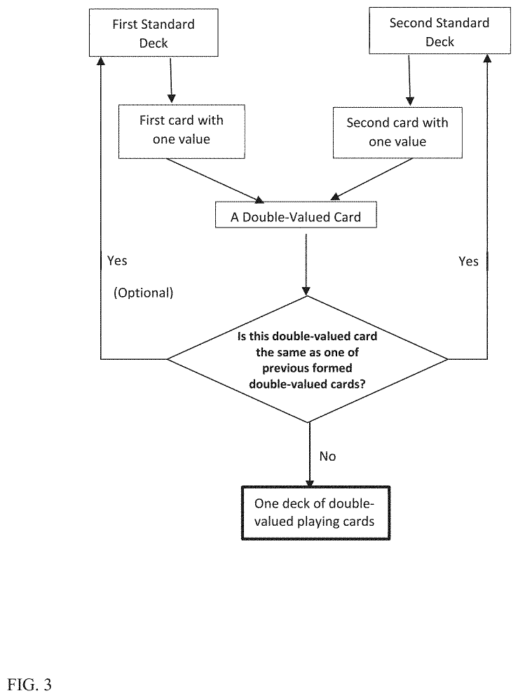

In one deck, though, it is possible that two cards could be identical with the exact same two values. For instance, one card has a 10 of diamonds coupled with a 2 of clubs. It is possible there is another card that has a 2 of clubs coupled with a 10 of diamonds. This might not be favorable for some card games. To eliminate the duplicate cards in one deck, a comparing step could be added to the process after two cards have been selected. Referring to the FIG. 3, if the combination of two cards is the same as one of the existing combination, the two cards are returned to its original deck and a new selection starts again till 52 double-valued cards are formed. Alternatively, if the combination of two cards is the same as one of the existing combination, only one of the card is returned to its corresponding deck, and replaced with a different card until the double-valued card is not identical to any of the previously formed double-valued cards till 52 different double-valued cards are formed.

In some embodiments, the present disclosure provides a card database in manufacturing process. The card database consisting a group of double-valued cards, and each double-valued playing card contains two values. The first value is selected from a group consisting of values of a first single-valued playing card deck, and the second value is selected from a group consisting of values of a second single-valued playing card deck. This card database is consisting of all the possible double-valued playing card combinations of the first single-valued playing card deck and the second single-valued playing card deck, and no two cards in the card database is identical

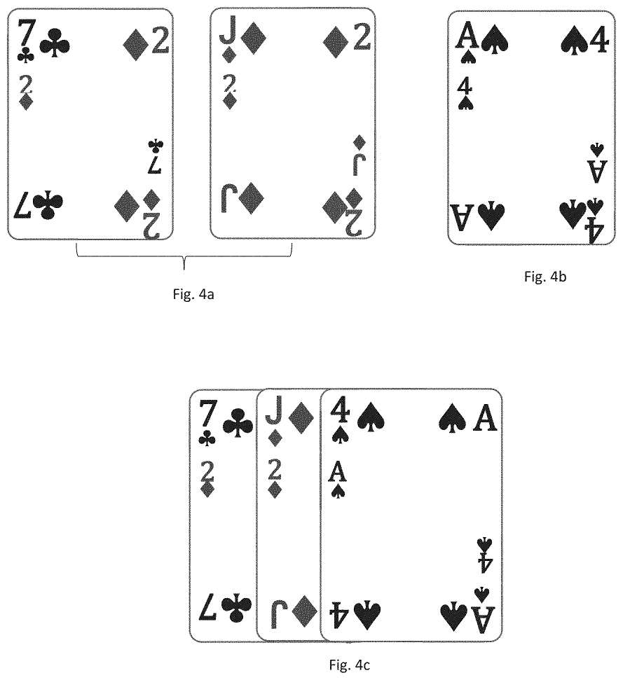

Based on this idea, formed from two modern standard 52-card decks, this card database contains 1378 possibilities of double-valued cards. To manufacture the present invention, a manufactory can pre-design all 1378 cards and label them in a card database. For instance, the card referring FIG. 1(a) could be named as, for example, AH5C in which A and 5 represent ranks, H represents Hearts and C represents Clubs. Each card in a standard deck is labeled in the same way. The two labels of two cards of which at least one card is randomly draw from two standard decks are combined and searched for the match in the card database that is labeled with the same four letters and/or numbers combination regardless the order. See FIG. 4. Repeat the process, and once 52 matches found, a deck of double-valued playing cards is formed. The rest is just to print and pack it. To eliminate duplicated cards, in the process of forming a deck, a card in the card database can only be matched once.

The present disclosure further provides methods of making the deck of double-valued playing cards described herein. In one aspect, the present disclosure provides a method of making the deck of playing cards, comprising steps of:
a. drawing a first card from a first single-valued playing card deck, wherein each value of the first single-valued playing card deck can only be selected once;
b. drawing a second card from a second single-valued playing card deck, wherein each value of the second single-valued playing card deck can only be selected once; combining the values of the first and the second cards to form one double-valued playing card; and
c. repeating steps a-c until all the double-valued playing cards are formed.

In another aspect, the present disclosure provides a method of making the deck of double-valued playing cards, wherein the deck of the playing cards does not contain the same double-valued playing cards, comprising steps of:
a. drawing a first card from a first single-valued playing card deck, wherein each value of the first single-valued playing card deck can only be selected once;
b. drawing a second card from a second single-valued playing card deck, wherein each value of the second single-valued playing card deck can only be selected once,
c. combining the values of the first and the second cards to form one double-valued playing card, wherein if the double-valued card is identical to one of the previously formed double-valued cards in the deck of playing cards, returning the second card back to the second single-valued playing card deck and repeating step b until the double-valued card is not identical to any of the previously formed double-valued cards in the deck of playing cards; and
d. repeating steps a-c until all the double-valued playing cards are formed.

In another aspect, the present disclosure provides a method of making the deck of double-valued playing cards, wherein the deck of the playing cards does not contain the same double-valued playing cards, comprising steps of:
a. manufacturing a card database consisting a group of double-valued cards, wherein each double-valued playing card contains two values,
the first value is selected from a group consisting of values of a first single-valued playing card deck,
the second value is selected from a group consisting of values of a second single-valued playing card deck,
the card database is consisting of all the possible double-valued playing card combinations of the first single-valued playing card deck and the second single-valued playing card deck, and
no two cards in the card database is identical drawing a first card from a first single-valued playing card deck, wherein each value of the first single-valued playing card deck can only be selected once;
b. drawing a second card from a second single-valued playing card deck, wherein each value of the second single-valued playing card deck can only be selected once;
c. combining the value of the first card and the second card to form one double-valued playing card, wherein if the double-valued card is identical to one of the previously formed double-valued cards in the deck of playing cards, returning the second card back to the second single-valued playing card deck and repeating step c until the double-valued card is not identical to any of the previously formed double-valued cards in the deck of playing cards;
d. selecting the double-valued card from the card database, which has the same values as the double-valued card formed in step d, to be one of the double-valued card in the deck of playing cards;
e. repeating steps b-e until all the double-valued playing cards are formed.

In another aspect, the present disclosure provides a method of making the deck of playing cards, wherein the deck of the playing cards contains 52 double-valued playing cards, with no two double-valued playing cards that are identical, comprising steps of:
a. drawing a first card from a first single-valued playing card deck, wherein each value of the first single-valued playing card deck can only be selected once;
b. drawing a second card from a second single-valued playing card deck, wherein each value of the second single-valued playing card deck can only be selected once;
c. combining the values of the first card and the value of the second card to form one double-valued playing card, wherein if the double-valued card is identical to one the previously formed double-valued cards in the deck of playing cards, returning the second card back to the second single-valued playing card deck and repeating step b until the double-valued card is not identical to any of the previously formed double-valued cards in the deck of playing cards; and
d. repeating steps a-c until all the 52 double-valued playing cards are formed.

In another aspect, the present disclosure provides a method of making the deck of double-valued playing cards, wherein the deck of the playing cards contains 52 double-valued playing cards, with no two double-valued playing cards that are identical, comprising steps of:
a. manufacturing a card database consisting a group of double-valued cards, wherein each double-valued playing card contains two values,
the first value is selected from a group consisting of values of a first single-valued playing card deck,
the second value is selected from a group consisting of values of a second single-valued playing card deck,
the first single-valued playing card deck and the second single-valued playing card deck are identical, and are consisting of four suits: clubs ( [symbol] ), diamonds (♦), hearts (♥), and spades ( [symbol] ), and each suit consisting of thirteen ranks from 2 through A (ace),
the card database is consisting of all the possible double-valued playing card combinations of the first single-valued playing card deck and the second single-valued playing card deck, and
no two cards in the card database is identical;
b. drawing a first card from a first single-valued playing card deck, wherein each value of the first single-valued playing card deck can only be selected once;
c. drawing a second card from a second single-valued playing card deck, wherein each value of the second single-valued playing card deck can only be selected once;
d. combining the values of the first card and the second card to form one double-valued playing card, wherein if the double-valued card is identical to one of the previously formed double-valued cards in the deck of playing cards, returning the second card back to the second single-valued playing card deck and repeating step c until the double-valued card is not identical to any of the previously formed double-valued cards in the deck of playing cards;
e. selecting the double-valued card from the card database, which has the same values as the double-valued card formed in step d, to be one of the double-valued card in the deck of playing cards;
f. repeating steps b-e until all the 52 double-valued playing cards are formed.

It is to understand that this particular selection process described above do not limit the present invention, but is merely illustrative of a possible method to form a deck of playing cards in the present invention. The combination of two values for each card or some cards in the present invention could be pre-determined.

Game Examples

In the present invention, a deck of double-valued cards provides 104 values to card games. High value cards are doubled for potential using which increases the chance of winning hands in some games. In addition, doubled values playing cards could provide means effectively against card counting strategies in games such as the blackjack. Many new playing cards games could be created in anticipation to utilize the innovation of the present invention.

On many existing playing cards games, the present invention could dramatically increase the versatilities therefore the attractions of the games. Two examples will be described herein. However, it is to be understand that the described games do not limit the present invention.

Blackjack—Blackjack is a quite popular playing cards game. Playing with the present invention, players would experience largely increased mental exercises and volatility of the game. For instance, in a blackjack game, if a player is dealt the first two cards referring to the FIG. 4(a), there are possible four combinations of which the results are 4, 9, 12 and 17. Being free to choose any one of the four combinations, the player is very likely to hit the third card. If the third card has an A of spades and a 4 of spades referring to the FIG. 4(b). With three double-valued cards, there are eight possible combinations. Of all eight combinations, the better hand is 20 (7, 2, A), but the best hand is 21 (7, J, 4) referring to the FIG. 4(c).

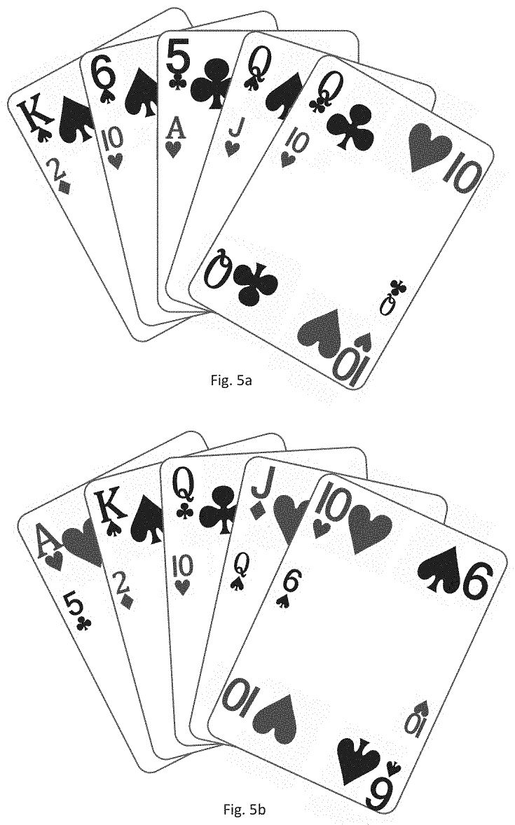

Poker games—Statistically, the 5 double-valued cards could form 2X2X2X2X2=32 hands while 5 conventional standard cards can only have one hand. Referring to the FIGS. 5(a) and (b), two possibilities are illustrated here as an example. Therefore, with the present invention players would have a new challenge that is to find the best possible hand which brings a good amount of brain exercises to players.

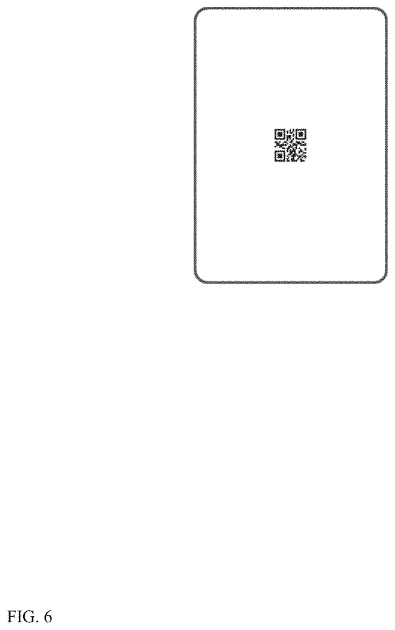

Now in reference to FIG. 6. FIG. 6 illustrates an exemplary embodiment of the identifier portion in accordance with an aspect of the invention. In a preferred embodiment, an apparatus for playing any one of a card game comprises: at least a single deck of playing cards; each card from the at least single deck with a double-value. Each double-valued playing card comprises two values: a first value and a second value, wherein the first value is selected from a first standard playing card deck of fifty-two cards. Furthermore, each value of the first single-valued playing card deck can only be selected once and the second value selected from a second standard playing card deck of fifty-two cards can only be selected once, wherein each of the fifty-two single-value cards of the first and second playing card deck is selected to compose the at least single deck of double-valued playing cards.

As shown in FIG. 6, in another aspect, a machine-readable code (identifier portion) may be disposed on any one of a front face or back face of each card, wherein the code is configured to be scanned by an image-capture device for processor-executable decoding to provide at least one of a deck origination, any one of card game rules, any one of a card game playing tip, card game fun fact or historical information, any one of a card game odds, manufacturing or retail details, or scan history. Furthermore, the identifier portion may be disposed on each of the double-valued playing cards or even single-valued standard playing cards.

The processor-executable decoding may provide any host of provisioning, most important of which is identifying the deck of single or double-valued cards that the scanned card belongs to. This information may be of importance, especially when engaging in a card game involving multiple decks. It would be critical, at the end of play, to reorganize the cards into their respective deck for future use. This application, along with the other listed provisioning, would be equally critical for both single-valued and double-valued playing cards alike.

In another application of the identifier portion, scanning a card or each card during the course of each deal over successive deals may, over time, graph a player history, which may be helpful to a player in developing strategy. Other applications of the identifier may provide additional server-supported analytics for a deeper and learned analysis of player history.

### Equivalent:

Those skilled in the art will recognize, or be able to ascertain using no more than routine experimentation, many equivalents to the specific embodiments and method described herein. Such equivalents are intended to be encompassed by the scope of the following claims.

It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims.

1. An apparatus for playing any one of a card game, said apparatus comprising:
at least a single deck of playing cards;
each card from said at least single deck with a double-value;
each double-valued playing card comprising two values: a first value and a second value, wherein the first value is selected from a first playing card deck of fifty-two cards, wherein each value of the first single-valued playing card deck can only be selected once and the second value selected from a second playing card deck of fifty-two cards, wherein each value of the second single-valued playing card deck can only be selected once; and
wherein each of the fifty-two single-value cards of the first and second playing card deck is selected to compose the at least single deck of double-valued playing cards.

2. The apparatus of claim 1, wherein one of the two values is positioned on the upper left-hand corner of the playing card, the other value is positioned upside-down on the lower right-hand corner of the playing card.

3. The apparatus of claim 1, wherein the first value is positioned on the upper left-hand corner of the playing card, the second value is positioned below the first value on the upper left-hand corner of the playing card, the second value is positioned upside-down on the lower right-hand corner of the playing card, and the first value is positioned upside-down on the lower right-hand corner of the playing card on top of the second value that is positioned upside-down on the lower right-hand corner of the playing card.

4. The apparatus of claim 1, wherein both the first value and the second value are randomly selected from the same standard single-valued deck.

5. The apparatus of claim 1, wherein both the first single-valued playing card deck and the second single-valued playing card deck is consisting of four suits: clubs ( [symbol] ), diamonds (♦), hearts (♥), and spades ( [symbol] ), and each suit consisting of thirteen ranks from 2 through A (ace).

6. An apparatus for playing any one of a card game, said apparatus comprising:
at least a single deck of playing cards;
each card from said at least single deck with a double-value;
each double-valued playing card comprising two values: a first value and a second value, wherein the first value is selected from a first standard playing card deck of fifty-two cards, wherein each value of the first single-valued playing card deck can only be selected once and the second value selected from a second standard playing card deck of fifty-two cards, wherein each value of the second single-valued playing card deck can only be selected once, wherein each of the fifty-two single-value cards of the first and second playing card deck is selected to compose the at least single deck of double-valued playing cards; and
a machine-readable code (identifier portion) on any one of a front face or back face of each card, wherein said code is configured to be scanned by an image-capture device for processor-executable decoding to provide at least one of a deck origination, any one of card game rules, any one of a card game playing tip, any one of a card game odds, any one of a card game historical fact, manufacturing or retail details, or scan history.

7. The apparatus of claim 6, wherein one of the two values is positioned on the upper left-hand corner of the playing card, the other value is positioned upside-down on the lower right-hand corner of the playing card.

8. The apparatus of claim 6, wherein the first value is positioned on the upper left-hand corner of the playing card, the second value is positioned below the first value on the upper left-hand corner of the playing card, the second value is positioned upside-down on the lower right-hand corner of the playing card, and the first value is positioned upside-down on the lower right-hand corner of the playing card on top of the second value that is positioned upside-down on the lower right-hand corner of the playing card.

9. The apparatus of claim 6, wherein both the first value and the second value are randomly selected from the same standard single-valued deck.

10. The apparatus of claim 6, wherein both the first single-valued playing card deck and the second single-valued playing card deck is consisting of four suits: clubs ( [symbol] ), diamonds (♦), hearts (♥), and spades ( [symbol] ), and each suit consisting of thirteen ranks from 2 through A (ace).

11. The apparatus of claim 6, wherein the identifier portion is at least one of a QR code, UPC code, 1D code, or 2D code.

12. An apparatus for playing any one of a card game, said apparatus comprising:
at least a single deck of playing cards, wherein each card of said deck comprises of at least one of a single or double value on each card;
an identifier portion comprising of a machine-readable code on any one of a front face or back face of each playing card in the at least single deck of cards, wherein said code is configured to be scanned by an image-capture device for processor-executable decoding to provide at least one of a deck origination, any one of card game rules, any one of a card game playing tip, any one of a card game odds, any one of a card game historical fact, manufacturing or retail details, or scan history.

13. The apparatus of claim 12, wherein one of the two values is positioned on the upper left-hand corner of the playing card, the other value is positioned upside-down on the lower right-hand corner of the playing card.

14. The apparatus of claim 12, wherein the first value is positioned on the upper left-hand corner of the playing card, the second value is positioned below the first value on the upper left-hand corner of the playing card, the second value is positioned upside-down on the lower right-hand corner of the playing card, and the first value is positioned upside-down on the lower right-hand corner of the playing card on top of the second value that is positioned upside-down on the lower right-hand corner of the playing card.

15. The apparatus of claim 12, wherein both the first value and the second value are randomly selected from the same standard single-valued deck.

16. The apparatus of claim 12, wherein both the first single-valued playing card deck and the second single-valued playing card deck is consisting of four suits: clubs ( [symbol] ), diamonds (♦), hearts (♥), and spades ( [symbol] ), and each suit consisting of thirteen ranks from 2 through A (ace).

17. The apparatus of claim 12, wherein the identifier portion is at least one of a QR code, UPC code, 1D code, or 2D code.

18. A method of making the double-valued deck of playing cards, said method comprising the steps of:
drawing a first card from a first single-valued playing card deck, wherein each value of the first single-valued playing card deck can only be selected once;
drawing a second card from a second single-valued playing card deck, wherein each value of the second single-valued playing card deck can only be selected once;
combining the values of the first and the second cards to form one double-valued playing cards;
repeating steps until all the double-valued playing cards are formed and whereby no single-valued cards from the first and second single-valued playing card deck is unselected; and
positioning an identifier portion comprising of a machine-readable code on any one of a front face or back face of each playing card in the at least single deck of cards, wherein said code is configured to be scanned by an image-capture device for processor-executable decoding to provide at least one of a deck origination, any one of card game rules, any one of a card game playing tip, any one of a card game odds, any one of card game historical fact, manufacturing or retail details, or scan history.

19. The method of claim 18, wherein no two values on any one card are the same in one deck.

20. The method of claim 18, wherein no two cards in one deck have the same two-value combinations.

21. The method of claim 18, wherein the value on the face of the card is depicted using any one of known or unknown illustrative or font styles.
